(19) United States
(12) Patent Application Publication
(10) Pub. No.: US 2021/0185285 A1
(43) Pub. Date: Jun. 17, 2021

(54) IMAGE PROCESSING METHOD AND APPARATUS, ELECTRONIC DEVICE, AND READABLE STORAGE MEDIUM

(71) Applicant: ZHEJIANG UNIVIEW TECHNOLOGIES CO., LTD., Hangzhou, Zhejiang (CN)

(72) Inventors: Yue SUN, Hangzhou, Zhejiang (CN); Qingjie FAN, Hangzhou, Zhejiang (CN)

(73) Assignee: ZHEJIANG UNIVIEW TECHNOLOGIES CO., LTD., Hangzhou, Zhejiang (CN)

(21) Appl. No.: 17/272,273

(22) PCT Filed: Sep. 18, 2018
(86) PCT No.: PCT/CN2018/106066

§ 371 Date: Feb. 26, 2021

(51) Int. Cl. H04N 9/04; G06T 7/13; G06T 7/174; H04N 1/60; H04N 9/68

(52) U.S. Cl. CPC H04N 9/04553; G06T 7/13; G06T 7/174; H04N 1/6008; G06T 2207/20224; H04N 1/6058; G06T 2207/10024; G06T 2207/10048; H04N 9/68

(57) ABSTRACT

Provided are an image processing method and apparatus, an electronic device, and a readable storage medium. Based on the edge detection result of pixels, the IR component image and the RGB component image are sequentially restored and obtained; when the color component is restored, the G component with higher resolution and more complete information is first restored, and then the R and B components are restored so that the restored color image has higher accuracy and image definition.

This application is a U.S. National Stage Application of PCT Application Serial No. PCT/CN2018/106066, filed Sep. 18, 2018, the disclosure of which is incorporated herein by reference in its entirety.

### TECHNICAL FIELD

This application relates to the technical field of image processing, in particular, an image processing method and apparatus, an electronic device, and a readable storage medium.

### BACKGROUND

The conventional color image sensor uses the Bayer format and mainly includes R, G, and B photosensitive units.

Referring to FIG. 1, based on the conventional RGB color image sensor, part of the color photosensitive units are replaced with an IR photosensitive unit, and the spectral distribution of the IR unit in the infrared band is similar to that of the RGB unit. In this manner, an RGB-IR image sensor is formed. Using the RGB-IR sensor, in conjunction with a specific image interpolation algorithm, the infrared light received by all the color RGB photosensitive units in the sensor array can be calculated, and after the infrared light is removed, the color image without color cast can be restored. Therefore, the RGB-IR sensor becomes an ideal solution to replace the IR-CUT switching apparatus. Further, through a single RGB-IR sensor, the visible light image and the infrared image of the same scenario can be obtained at the same time. In conjunction with specific image algorithm processing, the infrared image information is integrated into the original visible light image so that a color fusion image with higher imaging quality may be obtained. At present, this solution has been applied in some scenarios with harsh visible light imaging such as low-light and haze.

Currently, there are mainly two design schemes for the pixel arrangement of the common RGB-IR image sensor. Referring to FIG. 2, the first solution is that the pixels are arranged based on a 2×2 pixel array. Each 2×2 pixel array is composed of one R pixel, one G pixel, one B pixel, and one IR pixel, that is, the number ratio of each pixel unit in the sensor array is R:G:B:IR=1:1:1:1. This design is equivalent to replacing half of the G pixels with IR pixels based on the conventional color Bayer format. Referring to FIG. 3, the second solution is that the pixels are arranged based on a 4*4 pixel array. The number ratio of each pixel unit in this sensor array is R:G:B:IR=1:4:1:2. This design ensures that the resolution and definition of the G component are basically the same as the resolution and definition of the conventional color Bayer format.

### SUMMARY

Embodiments of this application provide an image processing method and apparatus, an electronic device, and a readable storage medium.

According to the first aspect, an embodiment of this application provides an image processing method for processing a first image collected by an RGB-IR image sensor. The RGB-IR image sensor includes a 4×4 pixel array. The method includes the steps described below.

Edge detection is performed on the first image so that an edge detection result of pixels in the first image is obtained.

A second image is obtained according to the first image and the edge detection result of the pixels. The second image is an IR component image corresponding to the first image.

The second image is subtracted from the first image so that a third image of visible light imaging is obtained.

A fourth image of a G component is obtained according to the third image and the edge detection result of the pixels.

A fifth image including R, G, and B components is obtained according to the third image, the fourth image, and the edge detection result of the pixels.

According to the second aspect, an embodiment of this application further provides an image processing apparatus. The apparatus is configured to process a first image collected by an RGB-IR image sensor. The RGB-IR image sensor includes a 4×4 pixel array. The apparatus includes an edge detection module, an IR component image obtaining module, a visible light imaging image obtaining module, a G component image obtaining module, and an RGB image obtaining module.

The edge detection module is configured to perform edge detection on the first image to obtain an edge detection result of the pixels in the first image.

The IR component image obtaining module is configured to obtain a second image according to the first image and the edge detection result of the pixels. The second image is an IR component image corresponding to the first image.

The visible light imaging image obtaining module is configured to subtract the second image from the first image to obtain a third image of visible light imaging.

The G component image obtaining module is configured to obtain a fourth image of a G component according to the third image and the edge detection result of the pixels.

The RGB image obtaining module is configured to obtain a fifth image including R, G, and B components according to the third image, the fourth image, and the edge detection result of the pixels.

According to the third aspect, an embodiment of this application further provides an electronic device. The electronic device includes a processor and a non-volatile memory storing multiple computer instructions. The electronic device is configured to, when the multiple computer instructions are executed by the processor, perform the image processing method described in the first aspect.

According to the fourth aspect, an embodiment of this application further provides a readable storage medium. The readable storage medium includes a computer program. The computer programs is configured to, when the computer program is running, control an electronic device where the readable storage medium is located to perform the image processing method described in the first aspect.

### BRIEF DESCRIPTION OF DRAWINGS

To illustrate solutions in embodiments of this application more clearly, the drawings used in the embodiments will be briefly described below. It is to be understood that the subsequent drawings only illustrate part of embodiments of this application and therefore should not be construed as limiting the scope, and those of ordinary skill in the art may obtain other related drawings based on these drawings on the premise that no creative work is done.

FIG. 1 is a curve diagram of the spectral response characteristic of the photosensitive unit of a conventional RGB-IR sensor;

FIG. 2 is a schematic diagram of an RGB-IR sensor array with a 2×2 pixel matrix as a constituent unit;

FIG. 3 is a schematic diagram of an RGB-IR sensor array with a 4×4 pixel matrix as a constituent unit;

FIG. 4 is a structural block diagram of an electronic device according to an embodiment of this application;

FIG. 5 is a flowchart of an image processing method according to an embodiment of this application;

FIG. 6 is a sub-step flowchart of step S510 of FIG. 5;

FIG. 7 is a sub-step flowchart of step S520 of FIG. 5;

FIG. 8 is a schematic diagram of the local pixel layout of the image collected by the RGB-IR sensor array in FIG. 3;

FIGS. 9A to 9C are schematic diagrams of the process of obtaining an IR component image in step S520 according to an embodiment of this application;

FIG. 10 is a sub-step flowchart of step S540 of FIG. 5;

FIG. 11 is a sub-step flowchart of step S550 of FIG. 5;

FIG. 12 is a flowchart of another image processing method according to an embodiment of this application;

FIG. 13 is a function module diagram of an image processing apparatus according to an embodiment of this application; and

FIG. 14 is a function module diagram of another image processing apparatus according to an embodiment of this application.

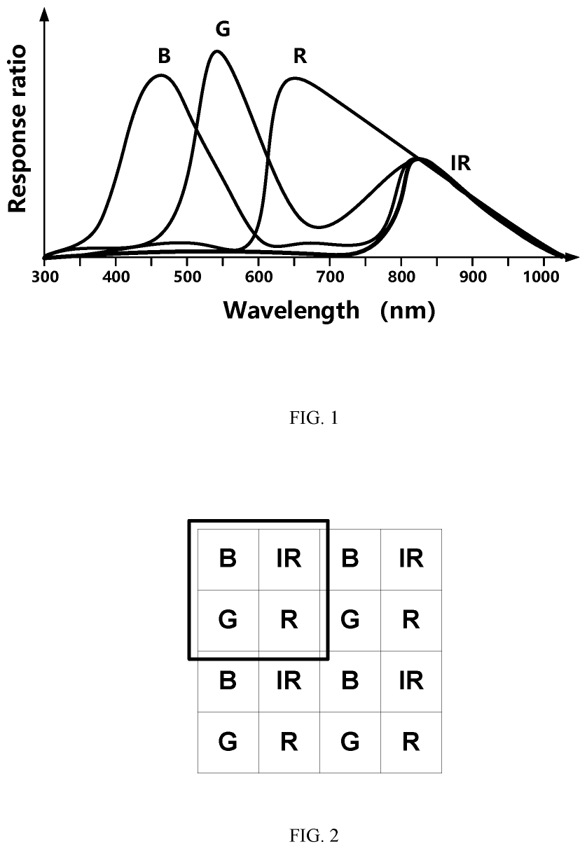

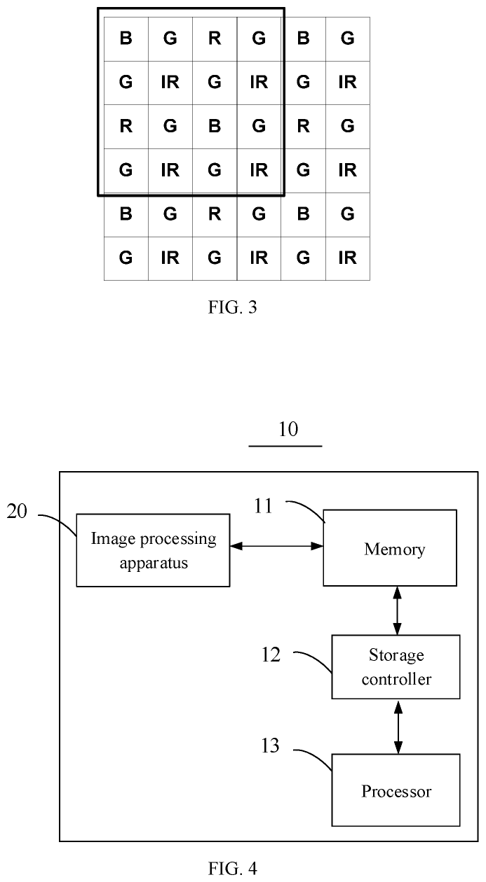

### DETAILED DESCRIPTION

The solutions in embodiments of this application will be described clearly and completely in conjunction with the drawing in embodiments of this application. Apparently, the embodiment described below is part, not all, of embodiments of this application. Generally, the components of embodiments of this application described and illustrated in the drawings herein may be arranged and designed through various configurations.

Therefore, the following detailed description of embodiments of this application shown in the drawings is not intended to limit the protection scope of this application, but merely illustrates the selected embodiments of this application. Based on embodiments of this application, all other embodiments obtained by those skilled in the art are within the protection scope of this application on the premise that no creative work is done.

It is to be noted that similar reference numerals and letters indicate similar items in the subsequent drawings, and therefore, once a particular item is defined in one drawing, the item needs no more definition and explanation in the subsequent drawings. In the description of this application, the terms “first”, “second”, etc. are only configured to distinguish the description and are not to be construed as indicating or implying relative importance.

Please refer to FIG. 4, FIG. 4 is a structural block diagram of an electronic device 10 according to an embodiment of this application. The electronic device 10 may be, but is not limited to, a smart phone, a personal computer (PC), a tablet computer, a personal digital assistant (PDA), a mobile Internet device (MID), a server and other terminal equipment with an image processing capability. The electronic device 10 may include an image processing apparatus 20, a memory 11, a storage controller 12, and a processor 13.

The memory 11, the storage controller 12, and the processor 13 are directly or indirectly in electrical connection to each other to implement data transmission or interactions. For example, the electrical connections between the memory 11, the storage controller 12, and the processor 13 may be implemented through one or more communication buses or signal lines. The image processing apparatus 20 is configured to process an image collected by an RGB-IR sensor array with a 4×4 pixel matrix as a constituent unit. In this embodiment, the RGB-IR sensor array with the 4×4 pixel matrix as the constituent unit may be part of the electronic device 10, and the image is directly processed after the RGB-IR sensor array obtains the image; or the RGB-IR sensor array with the 4×4 pixel matrix as the constituent unit is not part of the electronic device 10, and the image processing apparatus 20 processes the image which is collected by the RGB-IR sensor array and input to the electronic device 10. The image processing apparatus 20 may include at least one software function module that may be stored in the memory 11 in the form of software or firmware or fixed in an operating system (OS) of the electronic device 10. The processor 13 is configured to execute an executable module stored in the memory 11, such as software function modules and computer programs included in the image processing apparatus 20.

The memory 11 may be, but is not limited to, a random-access memory (RAM), a read-only memory (ROM), a programmable read-only memory (PROM), an erasable programmable read-only memory (EPROM), an electrically erasable programmable read-only memory (EEPROM) or the like. The memory 11 is configured to store programs, and the processor 13 executes the programs after receiving execution instructions. Accesses of the processor 13 and other components to the memory 11 may be performed under the control of the storage controller 12.

The processor 13 may be an integrated circuit chip with a signal processing capability. The processor 13 may be a general-purpose processor such as a central processing unit (CPU), a network processor (NP), a digital signal processor (DSP), an application-specific integrated circuit (ASIC), a field-programmable gate array (FPGA), or other programmable logic devices, discrete gates or transistor logic devices or discrete hardware components. The processor can implement or perform various methods, steps, and logic block diagrams disclosed in embodiments of the present application. The general-purpose processor may be a microprocessor or any conventional processor.

It is to be understood that the structure shown in FIG. 4 is merely illustrative. The electronic device 10 may further include more or fewer components than the components shown in the figure or may have a configuration different from the configuration shown in FIG. 4. Various components shown in FIG. 4 may be implemented by hardware, software, or a combination thereof.

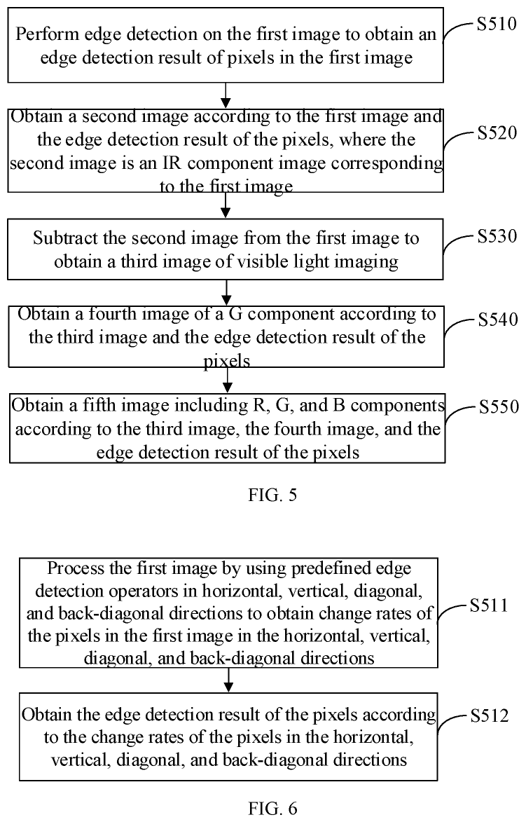

Please refer to FIG. 5, FIG. 5 is a flowchart of an image processing method applied to the electronic device 10 according to an embodiment of this application. This image processing method is used to process an image collected by an RGB-IR image sensor with a 4×4 pixel array. The detailed flow of this method is described below.

In step S510, edge detection is performed on the first image so that an edge detection result of the pixels in the first image is obtained.

In this step, the edge detection result of the pixels includes the detection results in four directions, namely, horizontal, vertical, diagonal, and back-diagonal directions. The edge information of all R, G, B, and IR channels of the original RGB-IR image is fully considered, which has better edge detection accuracy than the method in the existing art in which only the edge information of the G channel or the IR channel is used for reference.

Referring to FIG. 6, in an embodiment, step S510 may be implemented through the sub-steps described below.

In sub-step S511, the first image is processed by using edge detection operators in predefined horizontal, vertical, diagonal, and back-diagonal directions so that change rates of the pixels in the first image in horizontal, vertical, diagonal, and back-diagonal directions are obtained.

In this embodiment, edge detection operators in first, the horizontal, vertical, diagonal, and back-diagonal directions are defined. As shown in equation set (1), ωₕ and ωᵥ denote an edge detection operator in a horizontal direction and an edge detection operator in a vertical direction, respectively; ω_{d} and ω_{bd} denote an edge detection operator in a diagonal direction and an edge detection operator in a back-diagonal direction, respectively, and each are a 5×5 matrice. In the 5×5 matrice, except for non-zero elements on the diagonal and back-diagonal of the matrix, the other elements are all 0.

$$\begin{matrix}{ω}_{h} = [ \begin{matrix}- 1 & 0 & 2 & 0 & - 1\end{matrix} ] , {ω}_{v} = {[ \begin{matrix}- 1 & 0 & 2 & 0 & - 1\end{matrix} ]}^{T} , & ( 1 ) \\ {ω}_{d} = [ \begin{matrix} & & & & - 1 \\ & & & 0 & \\ & & 2 & & \\ & 0 & & & \\ - 1 & & & & \end{matrix} ] , {ω}_{bd} = [ \begin{matrix}- 1 & & & & \\ & 0 & & & \\ & & 2 & & \\ & & & 0 & \\ & & & & - 1\end{matrix} ] & \end{matrix}$$

The first image is processed by using the preceding edge detection operators so that the change rates of the pixels (per pixel) in the first image in the horizontal, vertical, diagonal, and back-diagonal directions are obtained. For details, please refer to equation set (2).

Δₕ=abs(I₁⊗ωₕ),Δᵥ=abs(I₁⊗ωᵥ),Δ_{d}=abs(I₁⊗φ_{d}),Δ_{bd}=abs(I₁⊗ω_{bd}) (2)

Δₕ, Δᵥ, Δ_{d} and Δ_{bd} denote the change rates of per pixel in the horizontal, vertical, diagonal, and back-diagonal directions, respectively, I₁ denotes the first image, ⊗ denotes the convolution operation, and abs( ) denotes the absolute value operation. To take into account the processing of the edge pixels of the image, the image may be expanded first (the number of expanded pixels on each edge is not less than 2). After the preceding convolution operation is completed, the image where change rates of the image are obtained is then reduced and restored to the same resolution as the original image I₁.

In step S512, the edge detection result of the pixels is obtained according to the change rates of the pixels in the horizontal, vertical, diagonal, and back-diagonal directions.

First, edge detection results of the pixels in horizontal, vertical, diagonal, and back-diagonal directions are calculated according to the change rates of the pixels in the horizontal, vertical, diagonal, and back-diagonal directions.

The edge detection results are quantified according to the change rates of the pixels in the horizontal, vertical, diagonal, and back-diagonal directions. With reference to equation set (3) and equation set (4), the quantified results of edge detection include two groups: the first group is the edge detection results Eₕ₋ᵥ in the horizontal and vertical directions; the second group is the quantified results E_{d-bd} in the diagonal and back-diagonal directions. Eₕ₋ᵥ and E_{d-bd} are described below.

$$\begin{matrix}{E}_{h - v} = \{ \begin{matrix}0 , & {Δ}_{h} > {α}_{1} \cdot {Δ}_{v} \\ 1 , & {Δ}_{v} > {α}_{1} \cdot {Δ}_{h} \\ 0.5 , & others\end{matrix} . & ( 3 ) \\ {E}_{d - bd} = \{ \begin{matrix}0 , & {Δ}_{d} > {α}_{2} \cdot {Δ}_{bd} \\ 1 , & {Δ}_{bd} < {α}_{2} \cdot {Δ}_{d} \\ 0.5 , & others\end{matrix} . & ( 4 )\end{matrix}$$

The parameters α1 and α2 may be adjusted according to the actual image effect so that the best edge detection accuracy can be achieved.

Then, smooth filtering processing is performed on the calculated edge detection results so that the edge detection result of the pixels is obtained.

Smooth filtering processing is performed on the two sets of edge detection results obtained above. The smooth filtering processing may use a simple linear filter (such as a mean filter and a Gaussian filter) or a non-linear filter with an edge retention capability (such as Guided filtering and bilateral filtering). After the smooth filtering processing, on the one hand, the influence of random signals such as noise on the edge detection accuracy is avoided, and on the other hand, the edge information of neighborhood pixels may be referred to each other through smooth processing, so as to achieve the effective use of the edge information of the full components (R, G, B, and IR).

In step S520, a second image is obtained according to the first image and the edge detection result of the pixels. The second image is an IR component image corresponding to the first image.

There is a problem of inconsistency of grayscale characteristics between the pure infrared image and the visible light image. If the RGB pixel value is introduced in the interpolation process of the IR channel, the problem of false signals existing at the edges and details may be caused. Therefore, during restoring the infrared pixel value, on the one hand, the preceding edge detection results are needed for reference, and on the other hand, it needs to be ensured that the RGB pixel value can not be used in the interpolation process of the IR channel. Similarly, the IR pixel value can not be used in the interpolation process of the RGB channel.

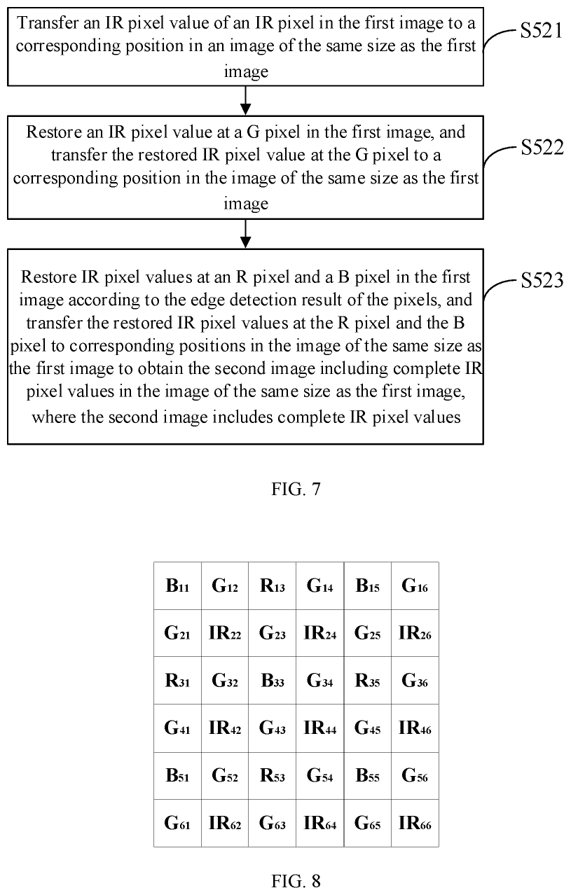

Referring to FIG. 7, step S520 includes the sub-steps described below.

In sub-step S521, an IR pixel value of an IR pixel in the first image is transferred to a corresponding position in an image of the same size as this first image.

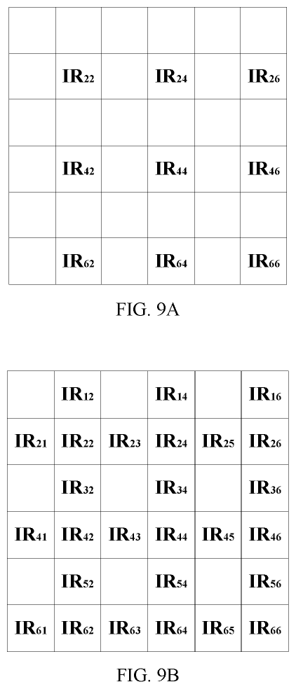

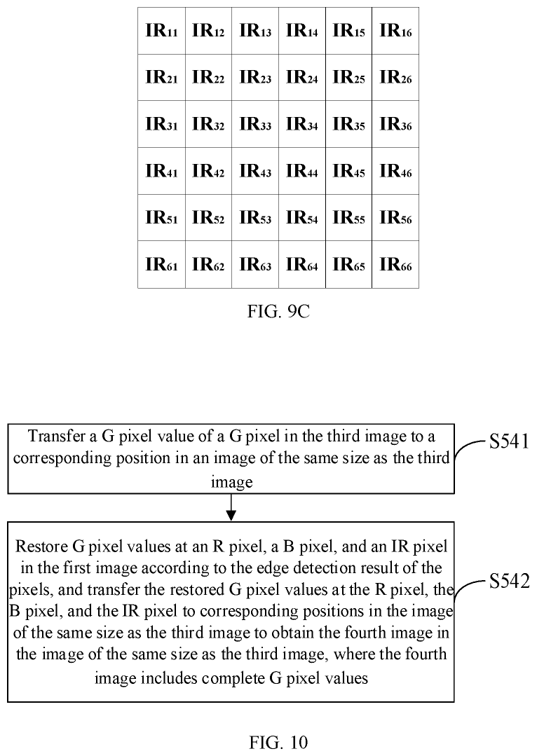

Referring to FIG. 8, first, the IR pixel value at the IR pixel in the image shown in FIG. 8 is transferred to the corresponding position in the image of the same size as this first image so that the image shown in FIG. 9A is obtained.

In sub-step S522, an IR pixel value at a G pixel in the first image is restored, and the restored IR pixel value at the G pixel is transferred to a corresponding position in the image of the same size as the first image.

With continued reference to FIG. 8, there are two cases for the relative positions of the G pixel and the IR pixel: the first case is like a G₂₃ pixel, and the left and right sides of the G₂₃ pixel are adjacent to one IR pixel; the second case is like a G₃₂ pixel, the upper and lower sides of the G₃₂ pixel are adjacent to one IR pixel. Any of the other positions of the G pixel and the IR pixel is necessarily one of the preceding two cases. Therefore, the IR pixel value at the G pixel is interpolated in the preceding two cases.

In the case where the G pixel to be interpolated is adjacent to the IR pixel in the horizontal direction, the IR interpolation result at this position is the average value of the pixel values of two IR pixels that are horizontally adjacent to the G pixel to be interpolated. For example, the G₂₃ pixel in FIG. 8 is used as an example, and then the IR interpolation result at the G₂₃ pixel position is: IR₂₃=(IR₂₂+IR₂₄)/2.

In the case where the G pixel to be interpolated is adjacent to the IR pixel in the vertical direction, the IR interpolation result at this position is the average value of the pixel values of two IR pixels that are vertically adjacent to the G pixel to be interpolated. For example, the G₃₂ pixel in FIG. 8 is used as an example, and then the IR interpolation result at the G₃₂ pixel position is: IR₃₂=(IR₂₂+R₄₂)/2.

The restored IR pixel value at the G pixel is transferred to FIG. 9A so that the image shown in FIG. 9B is obtained.

In sub-step S523, IR pixel values at an R pixel and a B pixel in the first image are restored according to the edge detection result of the pixels, and the restored IR pixel values at the R pixel and the B pixel are transferred to corresponding positions in the image of the same size as this first image so that the second image including complete IR pixel values is obtained in the image of the same size as this first image.

The IR pixel values at all R and B pixel in the first image are restored. As shown in FIG. 8, for all R or B pixels in the first image, the pixels at the four diagonally adjacent positions of all R or B pixels are IR pixels. The IR interpolation result at the R or B pixel is calculated by using the edge detection results and in conjunction with the four neighborhood IR pixel values. The B₃₃ pixel in FIG. 8 is used as an example. The pixels at four diagonally adjacent positions of the B₃₃ are IR₂₂, IR₂₄, IR₄₂, and IR₄₄, respectively. The value of the diagonal edge detection result at the B₃₃ pixel is E_{d-bd}(B₃₃), and then the IR interpolation result at the B₃₃ pixel is described below.

$$I {R}_{33} = \{ \begin{matrix}( I {R}_{22} + I {R}_{44} ) / 2 , & {E}_{d - bd} ( {B}_{33} ) < {T}_{1} \\ ( I {R}_{24} + I {R}_{42} ) / 2 , & {E}_{d - bd} ( {B}_{33} ) > 1 - {T}_{1} \\ ( I {R}_{22} + I {R}_{44} + I {R}_{24} + I {R}_{42} ) / 4 , & others\end{matrix} . \qquad ( 5 )$$

The threshold parameter T₁ may take a value range of [0, 0.5]. The greater the value of the threshold parameter is, the sharpness of the interpolation result is, but the more obvious the noise is. Therefore, it is necessary to select an appropriate threshold T₁ according to the actual image effect to take into account the noise and definition of the image.

E_{d-bd}(B₃₃) denotes the relative size relationship of the change rates of the B₃₃ pixel in the diagonal and back-diagonal directions. In the case where the E_{d-bd}(B₃₃) is smaller (the E_{d-ea}(B₃₃) is closer to 0), it indicates that the change rate of the B₃₃ pixel in the diagonal direction is greater than the change rate of the B₃₃ pixel in the back-diagonal direction, that is, the probability that the edge direction of the B₃₃ pixel is along the back-diagonal direction is greater, so the interpolation direction is along the back-diagonal direction; on the contrary, in the case where E_{d-bd}(B₃₃) is greater (E_{d-bd}(B₃₃) is closer to 1), it indicates that the probability that the edge direction of the B₃₃ pixel is along the diagonal direction is greater, so the interpolation direction is along the diagonal direction.

Through the preceding interpolation direction design, it can be ensured to the maximum extent that the interpolation direction is along the edge direction, thereby avoiding problems such as edge blur and image distortion caused by the interpolation operation.

The restored IR pixel values at all R and B pixel in the first image are transferred to the corresponding positions in FIG. 9B so that FIG. 9C is obtained. FIG. 9C is the second image including complete IR pixel values.

In step S530, the second image is subtracted from the first image so that a third image of visible light imaging is obtained.

After the IR component image (the second image) is subtracted from the first image, the third image of visible light imaging can be obtained.

In step S540, a fourth image of a G component is obtained according to the third image and the edge detection result of the pixels.

Referring to FIG. 10, in an embodiment, step S540 may be implemented through the sub-steps described below.

In sub-step S541, a G pixel value of a G pixel in the third image is transferred to a corresponding position in an image of the same size as this third image.

In sub-step S542, G pixel values at an R pixel, a B pixel, and an IR pixel in the first image are restored according to the edge detection result of the pixels, and the restored G pixel values at the R pixel, the B pixel, and the IR pixel are transferred to corresponding positions in the image of the same size as this third image so that the fourth image including complete G pixel values is obtained in the image of the same size as this third image.

With continued reference to FIG. 8, the four neighborhoods (pixels adjacent to the upper, lower, left, and right of the target pixel) of all R, B, and IR pixels in the image each are a G pixel. In conjunction with edge detection and four neighborhood G pixel values, the G pixel values at all R, B, and IR pixel can be obtained. The B₃₃ pixel in FIG. 8 is used as an example. The four neighborhood G pixel values of the B₃₃ pixel are G₃₂, G₂₃, G₃₄, and G₄₃, respectively. The value of the horizontal-vertical edge detection result at the B₃₃ pixel is Eₕ₋ᵥ(B₃₃), and then the G interpolation result at the B₃₃ pixel is described below.

$${G}_{33} = \{ \begin{matrix}( {G}_{23} + {G}_{43} ) / 2 , & {E}_{h - v} ( {B}_{33} ) < {T}_{2} \\ ( {G}_{32} + {G}_{34} ) / 2 , & {E}_{h - v} ( {B}_{33} ) > 1 - {T}_{2} \\ ( {G}_{23} + {G}_{43} + {G}_{32} + {G}_{34} ) / 4 , & others\end{matrix} . \qquad ( 6 )$$

The selection of the threshold parameter T₂ may refer to the selection manner of the threshold T₁ in equation (5). According to the same interpolation rule as equation (5), the G pixel values at all R, B, and IR pixel can be restored.

After the preceding sub-step S541 and sub-step S542 are completed, the fourth image of the complete G component can be obtained.

In step S550, a fifth image including R, G, and B components is obtained according to the third image, the fourth image, and the edge detection result of the pixels.

According to the third image, the fourth image, the edge detection result of the pixels, and the color difference constant method, the complete R and B channel images can be restored, and in conjunction with the restored G color channel image in the fourth image, a complete RGB image, that is, the fifth image can be obtained. In this embodiment, the complete R and B channel images may also be restored by using the color ratio constant method, and in conjunction with the restored G color channel image in the fourth image, a complete RGB image is obtained.

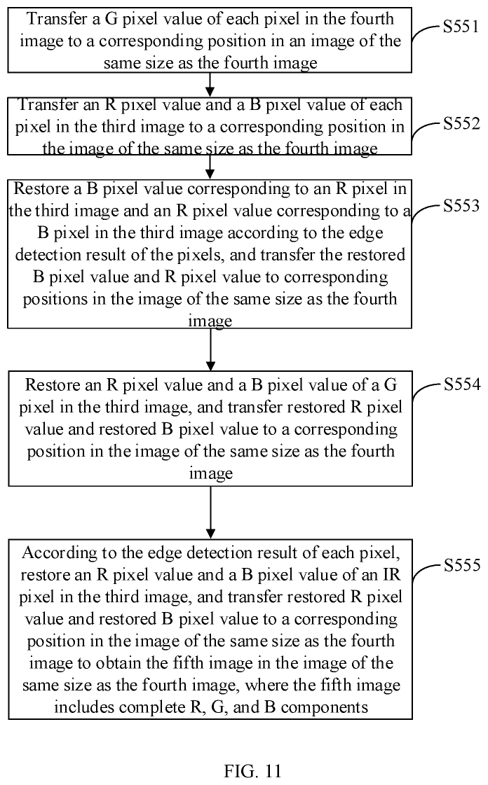

Referring to FIG. 11, in an embodiment, step S550 may be implemented through the sub-steps described below.

In sub-step S551, a G pixel value of each pixel in the fourth image is transferred to a corresponding position in an image of the same size as this fourth image.

In sub-step S552, an R pixel value and a B pixel value of each pixel in the third image are transferred to a corresponding position in the image of the same size as this fourth image.

In sub-step S553, a B pixel value at an R pixel in the third image and an R pixel value at a B pixel in the third image are restored according to the edge detection result of the pixels, and the restored B pixel value and R pixel value are transferred to corresponding positions in the image of the same size as this fourth image.

The B pixel values at all R pixel in the third image and the R pixel values at all B pixel in the third image are restored and transferred to the corresponding positions in the image of the same size as this fourth image. The method of restoring the B pixel values at the R pixel is consistent with the method of restoring the R pixel values at the B pixel, which is achieved by combining edge detection and the color difference constant method. The B₃₃ pixel in FIG. 8 is used as an example. The value of the horizontal-vertical edge detection result at the B₃₃ pixel is Eₕ₋ᵥ(B₃₃), and then the R interpolation result at the B₃₃ pixel is described below.

$${R}_{33} = \{ \begin{matrix}( {R}_{13} + {R}_{53} ) / 2 + ( 2 {G}_{33} - {G}_{13} - {G}_{53} ) / 2 , & {E}_{h - v} ( {B}_{33} ) < {T}_{3} \\ ( {R}_{31} + {R}_{35} ) / 2 + ( 2 {G}_{33} - {G}_{31} - {G}_{35} ) / 2 , & {E}_{h - v} ( {B}_{33} ) > 1 - {T}_{3} \\ \begin{matrix}( {R}_{13} + {R}_{53} + {R}_{31} + {R}_{35} ) / 4 + \\ ( 4 {G}_{33} - {G}_{13} - {G}_{53} - {G}_{31} - {G}_{35} ) / 4 ,\end{matrix} & others\end{matrix} . \qquad ( 7 )$$

The selection of the threshold parameter T₃ may refer to the selection manner of the threshold T₁ in equation (5). The B pixel value at the R pixel may be restored by using the same interpolation rule, which will not be repeated herein.

In sub-step S554, an R pixel value and a B pixel value of a G pixel in the third image are restored and transferred to a corresponding position in the image of the same size as this fourth image.

With continued reference to FIG. 8, there are two cases for the position of the G pixel relative to the R and B pixels: the first case is like a G₃₂ pixel, and the G₃₂ pixel is adjacent to the R and B pixels in the horizontal direction; the second case is like a G₂₃ pixel, and the G₂₃ pixel is adjacent to the R and B pixels in the vertical direction. Any of the other positions of the G pixel relative to the R and B pixels is necessarily one of the preceding two cases. Therefore, the R and B pixel values at the G pixel are restored in the preceding two cases.

In the case where the G pixel to be interpolated is adjacent to the R and B pixels in the horizontal direction, the R (or B) pixel value interpolation result at this G pixel is obtained according to the horizontally adjacent R (or B) and the G pixel value and in conjunction with the color difference constant method. For example, the G₃₂ pixel in FIG. 8 is used as an example, and then the R and B pixel value interpolation results at this G pixel are described below.

R₃₂=(R₃₁+R₃₃)/2+(2G₃₂−G₃₁−G₃₃)/2, B₃₂=(B₃₁+B₃₃)/2+(2G₃₂−G₃₁−G₃₃)/2. (8)

In the case where the to-be-interpolated G pixel is adjacent to the R and B pixels in the vertical direction, the R (or B) pixel value interpolation result at this position is obtained according to the vertically adjacent R (or B) and the G pixel value and in conjunction with the color difference constant method. For example, the G₂₃ pixel in FIG. 8 is used as an example, and then the R and B pixel value interpolation results at this position are described below.

R₂₃=(R₁₃+R₃₃)/2+(2G₂₃−G₁₃−G₃₃)/2, B₂₃=(B₁₃+B₃₃)/2+(2G₂₃−G₁₃−G₃₃)/2. (9)

In sub-step S555, according to the edge detection result of the pixels, an R pixel value and a B pixel value of an IR pixel in the third image are restored and transferred to corresponding positions in the image of the same size as this fourth image so that the fifth image including complete R, G, and B components is obtained in the image of the same size as this fourth image.

An R pixel value and a B pixel value at all IR pixel in the third image are restored and transferred to corresponding positions in the image of the same size as this fourth image. In this case, for any IR pixel in the image, the R and B pixel values in the four neighborhoods of this IR pixel are restored. Therefore, the R and B pixel values at this IR pixel can be restored through edge detection and the color difference constant method. The IR₂₂ pixel in FIG. 8 is used as an example. The value of the horizontal-vertical edge detection result at this IR₂₂ pixel is Eₕ₋ᵥ(IR₂₂), and then the R and B pixel value interpolation results at this IR₂₂ pixel are described below.

$${R}_{22} = \{ \begin{matrix}( {R}_{12} + {R}_{32} ) / 2 + ( 2 {G}_{22} - {G}_{12} - {G}_{32} ) / 2 , & {E}_{h - v} ( {IR}_{22} ) < {T}_{4} \\ ( {R}_{21} + {R}_{23} ) / 2 + ( 2 {G}_{22} - {G}_{21} - {G}_{23} ) / 2 , & {E}_{h - v} ( {IR}_{22} ) > 1 - {T}_{4} \\ \begin{matrix}( {R}_{12} + {R}_{32} + {R}_{21} + {R}_{23} ) / 4 + \\ ( 4 {G}_{22} - {G}_{12} - {G}_{32} - {G}_{21} - {G}_{23} ) / 4 ,\end{matrix} & others\end{matrix} . \\ {B}_{22} = \{ \begin{matrix}( {B}_{12} + {B}_{32} ) / 2 + ( 2 {G}_{22} - {G}_{12} - {G}_{32} ) / 2 , & {E}_{h - v} ( {IR}_{22} ) < {T}_{4} \\ ( {B}_{21} + {B}_{23} ) / 2 + ( 2 {G}_{22} - {G}_{21} - {G}_{23} ) / 2 , & {E}_{h - v} ( {IR}_{22} ) > 1 - {T}_{4} \\ \begin{matrix}( {B}_{12} + {B}_{32} + {B}_{21} + {B}_{23} ) / 4 + \\ ( 4 {G}_{22} - {G}_{12} - {G}_{32} - {G}_{21} - {G}_{23} ) / 4 ,\end{matrix} & others\end{matrix} . \qquad ( 10 )$$

The selection of the threshold parameter T₄ may refer to the selection manner of the threshold T₁ in equation (5).

After the preceding steps, an RGB image including R, G, and B components, that is, the fifth image can be obtained.

The preceding method provides an image collected by an RGB-IR image sensor designed based on a 4×4 pixel array. Through a full-component edge detection method and in conjunction with an improved RGB channel interpolation process, the preceding method has better interpolation accuracy and image restoration effect than the existing similar algorithm.

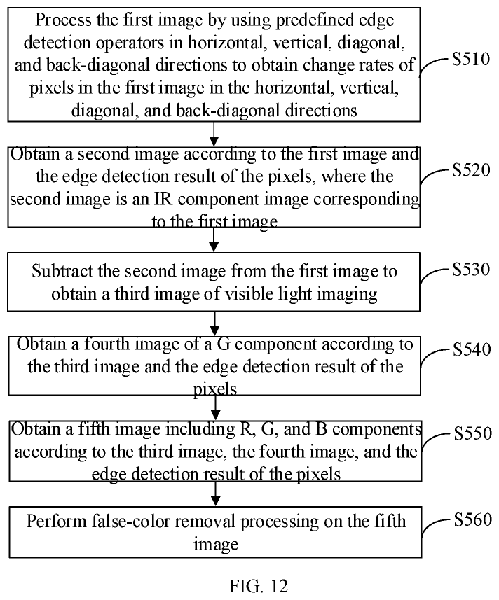

Referring to FIG. 12, in an embodiment of this application, the method may further include step S560.

In step S560, false-color removal processing is performed on the fifth image.

In this embodiment, step S560 may be implemented in the manner described below.

First, the fifth image is converted into a color space in which brightness and chroma are separated so that a sixth image is obtained. The color space in which brightness and chroma are separated may be one of the color spaces in which brightness and chroma are separated and with the standard definition such as YUV, YIQ, Lab, HSL, and HSV, or may be a customized color space in which the brightness component and the chroma component are expressed separately.

Next, a chroma component is analyzed so that a target processing area is determined.

The local detail and chroma information of the image is analyzed so that the local area where false colors may appear is determined for positioning and screening, and the target processing area is determined.

Then, the chroma component of the target processing area is attenuated.

Finally, gamut conversion is performed in conjunction with the original brightness component and the attenuated chroma component so that an RGB image after the false-color removal processing is obtained.

An embodiment of this application further provides an image processing apparatus 20. It may be understood that the specific functions performed by various hardware components involved in the image processing apparatus 20 to be described next have been described in the specific steps of the preceding embodiments, and the detailed functions corresponding to the various hardware components can be referred to the description of the preceding embodiments. Only a brief description of the image processing apparatus 20 is given below.

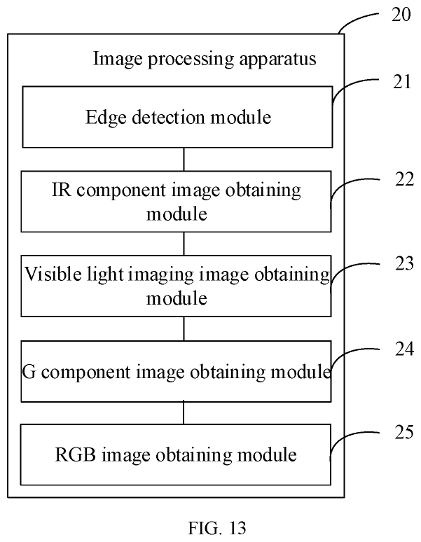

Referring to FIG. 13, the image processing apparatus 20 includes an edge detection module 21, an IR component image obtaining module 22, a visible light imaging image obtaining module 23, a G component image obtaining module 24, and an RGB image obtaining module 25.

The edge detection module 21 is configured to perform edge detection on the first image to obtain an edge detection result of the pixels in the first image.

The IR component image obtaining module 22 is configured to obtain a second image according to the first image and the edge detection result of the pixels. The second image is an IR component image corresponding to the first image.

The visible light imaging image obtaining module 23 is configured to subtract the second image from the first image to obtain a third image of visible light imaging.

The G component image obtaining module 24 is configured to obtain a fourth image of a G component according to the third image and the edge detection result of the pixels.

The RGB image obtaining module 25 is configured to obtain a fifth image including R, G, and B components according to the third image, the fourth image, and the edge detection result of the pixels.

In this embodiment, the edge detection module 21 is configured to process the first image by using predefined edge detection operators in horizontal, vertical, diagonal, and back-diagonal direction so that change rates of the pixels in the first image in the horizontal, vertical, diagonal, and back-diagonal directions are obtained.

The edge detection module 21 is configured to obtain the edge detection result of the pixels according to the change rates of the pixels in the horizontal, vertical, diagonal, and back-diagonal directions.

In this embodiment, the IR component image obtaining module 22 is configured to transfer an IR pixel value of an IR pixel in the first image to a corresponding position in an image of the same size as this first image.

The IR component image obtaining module 22 is configured to restore an IR pixel value at a G pixel in the first image, and transfer the restored IR pixel value at the G pixel to a corresponding position in the image of the same size as this first image.

The IR component image obtaining module 22 is configured to restore IR pixel values at an R pixel and a B pixel in the first image according to the edge detection result of the pixels, and transfer the restored IR pixel values at the R pixel and the B pixel to corresponding positions in the image of the same size as this first image so that the second image including complete IR pixel values is obtained in the image of the same size as this first image.

In this embodiment, the G component image obtaining module 24 is configured to transfer a G pixel value of a G pixel in the third image to a corresponding position in an image of the same size as this third image.

The G component image obtaining module 24 is configured to restore G pixel values at an R pixel, a B pixel, and an IR pixel in the first image according to the edge detection result of the pixels, and transfer the restored G pixel values at the R pixel, the B pixel, and the IR pixel to corresponding positions in the image of the same size as this third image so that the fourth image including complete G pixel values is obtained in the image of the same size as this third image.

In this embodiment, the RGB image obtaining module 25 is configured to transfer a G pixel value of each pixel in the fourth image to a corresponding position in an image of the same size as this fourth image.

The RGB image obtaining module 25 is configured to transfer an R pixel value and a B pixel value of each pixel in the third image to a corresponding position in the image of the same size as this fourth image.

The RGB image obtaining module 25 is configured to restore a B pixel value at an R pixel in the third image and an R pixel value at a B pixel in the third image according to the edge detection result of the pixels, and transfer the restored B pixel value and restored R pixel value to corresponding positions in the image of the same size as this fourth image.

The RGB image obtaining module 25 is configured to restore an R pixel value and a B pixel value of a G pixel in the third image, and transferred the restored R pixel value and the restored B pixel value to a corresponding position in the image of the same size as this fourth image.

The RGB image obtaining module 25 is configured to restore an R pixel value and a B pixel value of an IR pixel in the third image according to the edge detection result of the pixels, and transfer the restored R pixel value and the restored B pixel value to a corresponding position in the image of the same size as this fourth image so that the fifth image including complete R, G, and B components is obtained in the image of the same size as this fourth image.

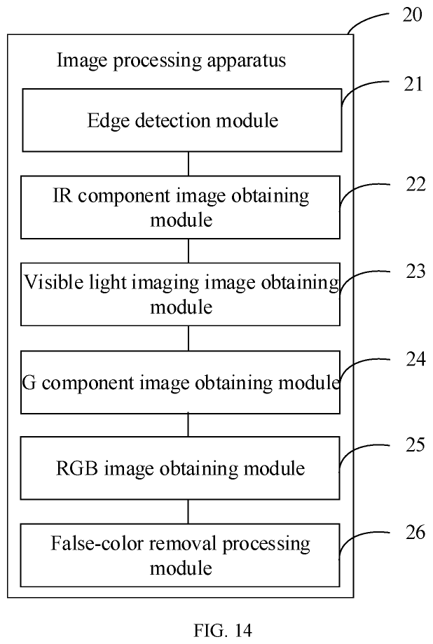

Referring to FIG. 14, the image processing apparatus 20 further includes a false-color removal processing module 26.

The false-color removal processing module 26 performs false-color removal processing on the fifth image.

The false-color removal processing module 26 is configured to convert the fifth image into a color space in which brightness and chroma are separated.

The false-color removal processing module 26 is configured to analyze a chroma component so that a target processing area is determined.

The false-color removal processing module 26 is configured to attenuate the chroma component of the target processing area.

The false-color removal processing module 26 is configured to perform gamut conversion between a brightness component and the attenuated chroma component so that an RGB image after the false-color removal processing is obtained.

The functional modules may be stored in a computer-readable storage medium if implemented in the form of software function modules and sold or used as independent products. Based on this understanding, the solutions of this application substantially, or the part contributing to the existing art, or part of the solutions may be embodied in the form of a software product. The computer software product is stored in a storage medium and includes multiple instructions for enabling corresponding devices to perform all or part of the steps of the method according to embodiments of this application. The preceding storage medium includes a USB flash disk, a mobile hard disk, a read-only memory (ROM), a random-access memory (RAM), a magnetic disk, an optical disk, or another medium capable of storing program codes.

To sum up, embodiments of this application provide an image processing method and apparatus, an electronic device, and a readable storage medium. Based on the edge detection result of the pixels, the IR component image and the RGB component image are sequentially restored and obtained; when the color component is restored, the G component with higher resolution and more complete information is first restored, and then the R and B components are restored so that the restored color image has higher accuracy and image definition. Meanwhile, the false-color removal processing is performed on the obtained RGB image so that the high-frequency false-color problem in the image can be effectively controlled and improved.

The above are only embodiments of this application and are not intended to limit this application. For those skilled in the art, this application may have various modifications and variations. Any modifications, equivalent substitutions, improvements and the like made within the spirit and principle of this application should fall within the protection scope of this application.

### INDUSTRIAL APPLICABILITY

The image processing method and apparatus, the electronic device, and the readable storage medium provided in embodiments of this application can enable the restored color image to have higher accuracy and image definition, and can effectively control and improve the high-frequency false-color problem in the image.

What is claimed is:

1. An image processing method for processing a first image collected by an RGB-IR image sensor, wherein the RGB-IR image sensor comprises a 4×4 pixel array, and the method comprises:
performing edge detection on the first image to obtain an edge detection result of pixels in the first image;
obtaining a second image according to the first image and the edge detection result of the pixels, wherein the second image is an IR component image corresponding to the first image;
subtracting the second image from the first image to obtain a third image of visible light imaging;
obtaining a fourth image of a G component according to the third image and the edge detection result of the pixels; and
obtaining a fifth image comprising R, G, and B components according to the third image, the fourth image, and the edge detection result of the pixels.

2. The method of claim 1, wherein the performing the edge detection on the first image to obtain the edge detection result of the pixels in the first image comprises:
processing the first image by using predefined edge detection operators in horizontal, vertical, diagonal, and back-diagonal directions to obtain change rates of the pixels in the first image in the horizontal, vertical, diagonal, and back-diagonal directions; and
obtaining the edge detection result of the pixels according to the change rates of the pixels in the horizontal, vertical, diagonal, and back-diagonal directions.

3. The method of claim 2, wherein the obtaining the edge detection result of the pixels according to the change rates of the pixels in the horizontal, vertical, diagonal, and back-diagonal directions comprises:
calculating edge detection results of the pixels in the horizontal, vertical, diagonal, and back-diagonal directions according to the change rates of the pixels in the horizontal, vertical, diagonal, and back-diagonal directions; and
performing smooth filtering processing on the calculated edge detection results to obtain the edge detection result of the pixels.

4. The method of claim 1, wherein the obtaining the second image according to the first image and the edge detection result of the pixels comprises:
transferring an IR pixel value of an IR pixel in the first image to a corresponding position in an image of the same size as the first image;
restoring an IR pixel value at a G pixel in the first image, and transferring the restored IR pixel value at the G pixel to a corresponding position in the image of the same size as the first image; and
restoring IR pixel values at an R pixel and a B pixel in the first image according to the edge detection result of the pixels, and transferring the restored IR pixel values at the R pixel and the B pixel to corresponding positions in the image of the same size as the first image to obtain the second image in the image of the same size as the first image, wherein the second image comprises complete IR pixel values.

5. The method of claim 1, wherein the obtaining the fourth image of a G component according to the third image and the edge detection result of the pixels comprises:
transferring a G pixel value of a G pixel in the third image to a corresponding position in an image of the same size as the third image; and
restoring G pixel values at an R pixel, a B pixel, and an IR pixel in the first image according to the edge detection result of the pixels, and transferring the restored G pixel values at the R pixel, the B pixel, and the IR pixel to corresponding positions in the image of the same size as the third image to obtain the fourth image in the image of the same size as the third image, wherein the fourth image comprises complete G pixel values.

6. The method of claim 1, wherein the obtaining the fifth image comprising the R, G, and B components according to the third image, the fourth image, and the edge detection result of the pixels comprises:
transferring a G pixel value of each pixel in the fourth image to a corresponding position in an image of the same size as the fourth image;
transferring an R pixel value and a B pixel value of each pixel in the third image to a corresponding position in the image of the same size as the fourth image;
restoring a B pixel value at an R pixel in the third image and an R pixel value at a B pixel in the third image according to the edge detection result of the pixels, and transferring the restored B pixel value and the restored R pixel value to corresponding positions in the image of the same size as the fourth image;
restoring an R pixel value and a B pixel value at a G pixel in the third image, and transferring the restored R pixel value and the restored B pixel value to a corresponding position in the image of the same size as the fourth image; and
restoring an R pixel value and a B pixel value at an IR pixel in the third image according to the edge detection result of the pixels, and transferring the restored R pixel value and the restored B pixel value to a corresponding position in the image of the same size as the fourth image to obtain the fifth image in the image of the same size as the fourth image, wherein the fifth image comprises complete R, G, and B components.

7. The method of claim 1, further comprising performing false-color removal processing on the fifth image, wherein the performing false-color removal processing on the fifth image comprises:
converting the fifth image into a color space in which brightness and chroma are separated; analyzing a chroma component to determine a target processing area;
attenuating the chroma component of the target processing area; and
performing gamut conversion between a brightness component and attenuated chroma component to obtain an RGB image after the false-color removal processing.

8. An image processing apparatus, wherein the apparatus is configured to process a first image collected by an RGB-IR image sensor, wherein the RGB-IR image sensor comprises a 4×4 pixel array, and the apparatus comprises:
an edge detection module configured to perform edge detection on the first image to obtain an edge detection result of pixels in the first image;
an IR component image obtaining module configured to obtain a second image according to the first image and the edge detection result of the pixels, wherein the second image is an IR component image corresponding to the first image;
a visible light imaging image obtaining module configured to subtract the second image from the first image to obtain a third image of visible light imaging;
a G component image obtaining module configured to obtain a fourth image of a G component according to the third image and the edge detection result of the pixels; and
an RGB image obtaining module configured to obtain a fifth image comprising R, G, and B components according to the third image, the fourth image, and the edge detection result of the pixels.

9. The apparatus of claim 8, wherein the edge detection module is configured to:
process the first image by using predefined edge detection operators in horizontal, vertical, diagonal, and back-diagonal directions to obtain change rates of the pixels in the first image in the horizontal, vertical, diagonal, and back-diagonal directions; and
obtain the edge detection result of the pixels according to the change rates of the pixels in the horizontal, vertical, diagonal, and back-diagonal directions.

10. The apparatus of claim 9, wherein the edge detection module is configured to:
calculate edge detection results of the pixels in the horizontal, vertical, diagonal, and back-diagonal directions according to the change rates of the pixels in the horizontal, vertical, diagonal, and back-diagonal directions; and
perform smooth filtering processing on the calculated edge detection results to obtain the edge detection result of the pixels.

11. The apparatus of claim 8, wherein the IR component image obtaining module is configured to:
transfer an IR pixel value of an IR pixel in the first image to a corresponding position in an image of the same size as the first image;
restore an IR pixel value at a G pixel in the first image, and transfer the restored IR pixel value at the G pixel to a corresponding position in the image of the same size as the first image; and
restore IR pixel values at an R pixel and a B pixel in the first image according to the edge detection result of the pixels, and transfer restored IR pixel values at the R pixel and the B pixel to corresponding positions in the image of the same size as the first image to obtain the second image in the image of the same size as this first image, wherein the second image comprises complete IR pixel values.

12. The apparatus of claim 8, wherein the G component image obtaining module is configured to:
transfer a G pixel value of a G pixel in the third image to a corresponding position in an image of the same size as the third image; and
restore G pixel values at an R pixel, a B pixel, and an IR pixel in the first image according to the edge detection result of the pixels, and transfer the restored G pixel values at the R pixel, the B pixel, and the IR pixel to corresponding positions in the image of the same size as the third image to obtain the fourth image in the image of the same size as the third image, wherein the fourth image comprises complete G pixel values.

13. The apparatus of claim 8, wherein the RGB image obtaining module is configured to:
transfer a G pixel value of each pixel in the fourth image to a corresponding position in an image of the same size as the fourth image;
transfer an R pixel value and a B pixel value of each pixel in the third image to a corresponding position in the image of the same size as the fourth image;
restore a B pixel value at an R pixel in the third image and an R pixel value at a B pixel in the third image according to the edge detection result of the pixels, and transfer the restored B pixel value and the restored R pixel value to corresponding positions in the image of the same size as the fourth image;
restore an R pixel value and a B pixel value at a G pixel in the third image, and transfer the restored R pixel value and the restored B pixel value to a corresponding position in the image of the same size as the fourth image; and
restore an R pixel value and a B pixel value at an IR pixel in the third image according to the edge detection result of the pixels, and transfer the restored R pixel value and the restored B pixel value to a corresponding position in the image of the same size as the fourth image to obtain the fifth image in the image of the same size as the fourth image, wherein the fifth image comprises complete R, G, and B components.

14. The apparatus of claim 8, further comprising a false-color removal processing module configured to perform false-color removal processing on the fifth image, wherein the false-color removal processing module is configured to:
convert the fifth image into a color space in which brightness and chroma are separated; analyze a chroma component to determine a target processing area;
attenuate the chroma component of the target processing area; and
perform gamut conversion between a brightness component and attenuated chroma component to obtain an RGB image after the false-color removal processing.

15. An electronic device, comprising a processor and a non-volatile memory storing a plurality of computer instructions, wherein the electronic device is configured to, when the plurality of the computer instructions are executed by the processor, perform a image processing method for processing a first image collected by an RGB-IR image sensor, wherein the RGB-IR image sensor comprises a 4×4 pixel array, and the method comprises:
performing edge detection on the first image to obtain an edge detection result of pixels in the first image;
obtaining a second image according to the first image and the edge detection result of the pixels, wherein the second image is an IR component image corresponding to the first image;
subtracting the second image from the first image to obtain a third image of visible light imaging;
obtaining a fourth image of a G component according to the third image and the edge detection result of the pixels; and
obtaining a fifth image comprising R, G and B components according to the third image, the fourth image, and the edge detection result of the pixels.

16. A readable storage medium, comprising a computer program, wherein the computer program is configured to, when the computer program is running, control an electronic device where the readable storage medium is located to perform the image processing method of claim 1.

17. The method of claim 2, further comprising performing false-color removal processing on the fifth image, wherein the performing false-color removal processing on the fifth image comprises:
converting the fifth image into a color space in which brightness and chroma are separated; analyzing a chroma component to determine a target processing area;
attenuating the chroma component of the target processing area; and
performing gamut conversion between a brightness component and attenuated chroma component to obtain an RGB image after the false-color removal processing.

18. The method of claim 3, further comprising performing false-color removal processing on the fifth image, wherein the performing false-color removal processing on the fifth image comprises:
converting the fifth image into a color space in which brightness and chroma are separated;
analyzing a chroma component to determine a target processing area;
attenuating the chroma component of the target processing area; and
performing gamut conversion between a brightness component and attenuated chroma component to obtain an RGB image after the false-color removal processing.

19. The apparatus of claim 9, further comprising a false-color removal processing module configured to perform false-color removal processing on the fifth image, wherein the false-color removal processing module is configured to:
convert the fifth image into a color space in which brightness and chroma are separated;
analyze a chroma component to determine a target processing area;
attenuate the chroma component of the target processing area; and
perform gamut conversion between a brightness component and attenuated chroma component to obtain an RGB image after the false-color removal processing.

20. The apparatus of claim 10, further comprising a false-color removal processing module configured to perform false-color removal processing on the fifth image, wherein the false-color removal processing module is configured to:
convert the fifth image into a color space in which brightness and chroma are separated;
analyze a chroma component to determine a target processing area;
attenuate the chroma component of the target processing area; and
perform gamut conversion between a brightness component and attenuated chroma component to obtain an RGB image after the false-color removal processing.
